(19) United States
(12) Patent Application Publication
(10) Pub. No.: US 2018/0276766 A1
(43) Pub. Date: Sep. 27, 2018

(54) AUTOMATIC JOURNALIZING DEVICE FOR TRANSACTION DETAILS, AUTOMATIC JOURNALIZING METHOD, AND AUTOMATIC JOURNALIZING PROGRAM

(71) Applicant: INFOMART CORPORATION, Tokyo (JP)

(72) Inventors: Katsuteru Murakami, Tokyo (JP); Osamu Nagahama, Tokyo (JP); Yasushi Nakai, Tokyo (JP); Rintaro Sonoda, Tokyo (JP); Hiroyuki Omura, Tokyo (JP); Shinji Tokuyama, Tokyo (JP)

(21) Appl. No.: 15/919,409

(22) Filed: Mar. 13, 2018

(30) Foreign Application Priority Data
Mar. 24, 2017 (JP) 2017-058846

(51) Int. Cl. G06Q 40/00

(52) U.S. Cl. CPC G06Q 40/125; G06Q 40/128

(57) ABSTRACT

An automatic journalizing device includes a collation unit that collates the content of journalizing target detail data which is input by a detail data input unit with the content of already journalized detail data stored in a detail data storage unit, so as to determine whether or not a determination item matches each other, and an automatic journalizing unit that sets the same account title as an account title set for the already journalized detail data, for the journalizing target detail data, in a case where it is determined that matching occurs. By using already journalized detail data for which an account title is already set without using a correspondence table related to a keyword, it is possible to prevent the occurrence of a problem that accurate automatic journalizing cannot be performed since there is no keyword of the correspondence table or a plurality of keywords are included.

### BACKGROUND OF THE INVENTION

### Field of the Invention

The present invention relates to an automatic journalizing device for transaction details, an automatic journalizing method, and an automatic journalizing program, and is suitable to be used for, particularly, a device which automatically journalizes a transaction which has occurred into an account title and registers the transaction.

### Background Art

Nowadays, generally, business accounting is processed by using tools such as accounting software available in the market or an in-company system, which is prepared for an accounting process. Even in a case of using such tools, it is essential that each transaction which has occurred is journalized into a predetermined account title so as to be registered as journal data, and thus general ledger data is created. Registration work of such journal data is performed as daily work by a person in charge in a company.

In the related art, there is a system which automatically creates journal data (for example, refer to Japanese Patent No. 5503795). An accounting process device disclosed in Japanese Patent No. 5503795 automatically journalizes each transaction into a specific account title by referring to a correspondence table in which a correspondence between keywords possibly included in a description of the transaction content and account titles is stored, on the basis of the description of the transaction content of each transaction, and creates journal data including at least the date, the transaction content, an amount of money, and an account title. In a case where automatic journalizing is performed by referring to the correspondence table related to a keyword as mentioned above, a plurality of keywords of the correspondence table may be included in a description of the transaction content. In this case, the accounting process device disclosed in Japanese Patent No. 5503795 performs automatic journalizing on the basis of a keyword having the highest priority among a plurality of keywords included in the description of the transaction content by referring to the correspondence table by applying a priority rule for a keyword.

### SUMMARY OF THE INVENTION

However, in the accounting process device disclosed in Japanese Patent No. 5503795, there is a problem in that automatic journalizing cannot be performed on the transaction content without a keyword in the correspondence table. In a case where a plurality of keywords are included in a description of the transaction content, since automatic journalizing is merely performed on the basis of a keyword having the highest priority, and thus there is a problem in that journalizing is not necessarily correct, and thus wrong automatic journalizing is often performed.

The present invention has been made in order to solve the problems, and an object thereof is to automatically journalize each transaction without using a correspondence table related to a keyword.

In order to solve the above-described problem, in the present invention, content of detail data which is input as a journalizing target is collated with content of detail data which has already been journalized, so as to determine whether or not content of a determination item set in advance matches each other. In a case where it is determined that the content of the determination item matches each other, the same account title as an account title set for the already journalized detail data is set for the detail data which is input as the journalizing target.

According to the present invention configured as mentioned above, already journalized detail data for which an account title has already been set is used to automatically journalize detail data which is input as a journalizing target on the basis of the transaction content. Thus, according to the present invention, it is possible to automatically journalize detail data of each transaction without using a correspondence table related to a keyword. Consequently, it is possible to prevent the occurrence of a problem that automatic journalizing cannot be performed since there is no keyword of a correspondence table in a description of the transaction content, or wrong automatic journalizing is performed since a plurality of keywords are included in a description of the transaction content.

### BRIEF DESCRIPTION OF THE DRAWINGS

FIG. 1 is a block diagram illustrating a functional configuration example of an automatic journalizing device for transaction details according to the present embodiment.

FIG. 2 is a diagram illustrating an example of detail data which is input by a detail data input unit of the present embodiment.

FIG. 3 is a diagram illustrating examples of determination items used by a collation unit of the present embodiment.

FIG. 4 is a flowchart illustrating an operation example of the automatic journalizing device according to the present embodiment.

### DETAILED DESCRIPTION OF THE INVENTION

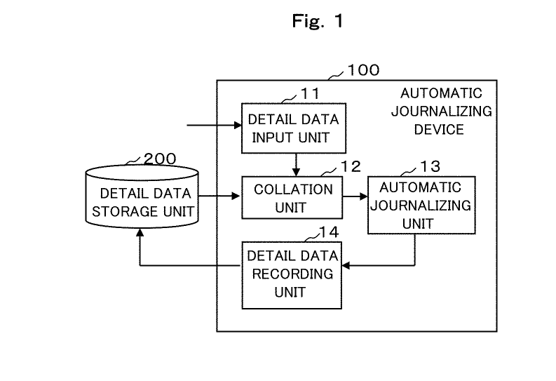

Hereinafter, an embodiment of the present invention will be described with reference to the drawings. FIG. 1 is a block diagram illustrating a functional configuration example of an automatic journalizing device for transaction details according to the present embodiment.

As illustrated in FIG. 1, an automatic journalizing device 100 of the present embodiment is connected to a detail data storage unit 200. The detail data storage unit 200 stores detail data (hereinafter, referred to as already journalized detail data) which has already been journalized for various transactions. The automatic journalizing device 100 of the present embodiment automatically journalizes a transaction related to new detail data which is a journalizing target into a specific account title by using the already journalized detail data stored in the detail data storage unit 200.

Herein, an example is described in which the automatic journalizing device 100 and the detail data storage unit 200 are configured separately, but there may be a configuration in which the detail data storage unit 200 is built into the automatic journalizing device 100. Here, an example is described in which the detail data storage unit 200 is directly connected to the automatic journalizing device 100, but this aspect is only an example. For example, there may be an aspect in which a server on a communication network such as the Internet includes the detail data storage unit 200, and the server is connected to the automatic journalizing device 100 via the communication network.

As illustrated in FIG. 1, the automatic journalizing device 100 of the present embodiment includes, as functional constituent elements, a detail data input unit 11, a collation unit 12, an automatic journalizing unit 13, and a detail data recording unit 14. The functional blocks 11 to 14 may be configured by using any of hardware, a digital signal processor (DSP), and software. For example, in a case where the functional blocks are configured by using software, each of the functional blocks 11 to 14 is actually configured to include a CPU, a RAM, a ROM, and the like of a computer, and is realized by executing a program stored in a recording medium such as the RAM, the ROM, a hard disk, or a semiconductor memory.

The software for realizing a function of each of the functional blocks 11 to 14 of the automatic journalizing device 100 is installed as, for example, a web application on a server. In this case, detail data which is automatically journalized is formed of web format data. However, detail data which is input to the automatic journalizing device 100 by the detail data input unit 11 may have a web format, and may be converted into a predetermined format so as to be processed in the collation unit 12, the automatic journalizing unit 13, and the detail data recording unit 14.

The software for realizing the function of each of the functional blocks 11 to 14 of the automatic journalizing device 100 may be installed as an application installed in a personal computer, a tablet terminal, or the like. In this case, detail data which is automatically journalized is not limited to web format data, and may be data with any format which can be processed by the application.

The detail data input unit 11 inputs new detail data (hereinafter, referred to as journalizing target detail data) which is a journalizing target. For example, the detail data input unit 11 inputs detail data which is issued for each transaction in an ordering system, a bill issuing system, or the like. Specifically, the system and the automatic journalizing device 100 are connected to each other via a communication network, and the detail data input unit 11 inputs, in response to a user's operation or automatically, detail data issued by the system. There may be an aspect in which the system has the function of the automatic journalizing device 100.

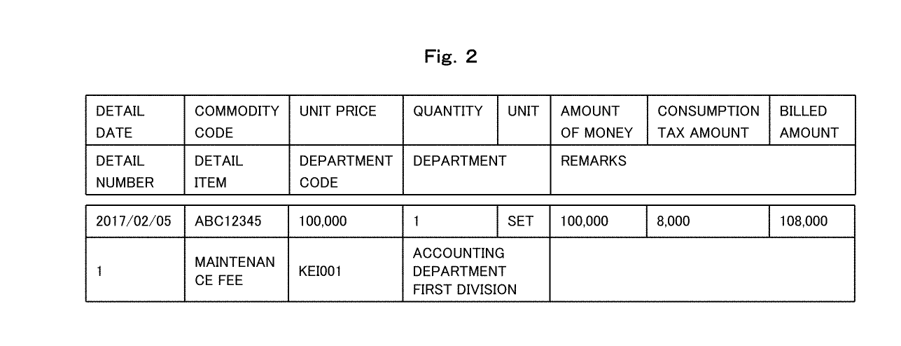

FIG. 2 is a diagram illustrating an example of detail data which is input by the detail data input unit 11. A single piece of detail data indicates a single transaction, and a single account title is set for the single transaction. As illustrated in FIG. 2, the detail data includes a plurality of description items for indicating the content of a transaction. Specifically, the description items such as the detail date, a detail number, a commodity code, a detail item, a unit price, a quantity, a unit, an amount of money, a consumption tax amount, a billed amount, a department code, a department name, and remarks are included.

The collation unit 12 collates the content of the journalizing target detail data which is input by the detail data input unit 11 with the content of already journalized detail data stored in the detail data storage unit 200, and determines whether or not the content of a preset determination item among the respective description items included in both pieces of the detail data matches each other.

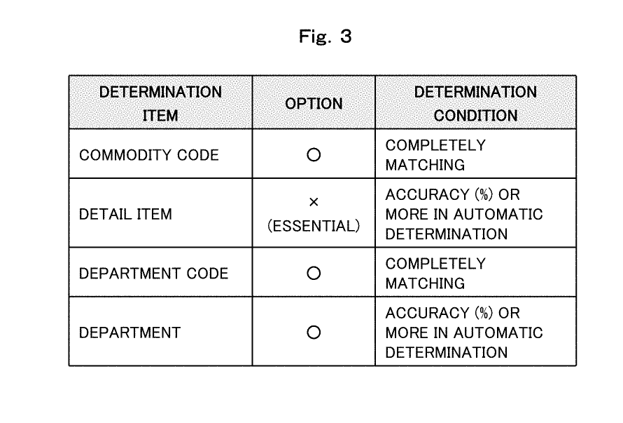

As illustrated in FIG. 3, in the present embodiment, among the above-described respective description items, four items such as the commodity code, the detail item, the department code, and the department name are set as determination items. Above all, the detail item is an essential determination item. Three determination items such as the commodity code, the department code, and the department name may be arbitrarily set by a user. A completely matching determination is performed on the commodity code and the department code, and a similarity determination is performed on the detail item and the department name. A criterion for the determination accuracy regarding whether matching is regarded in a case where what extent of the similarity is obtained may be arbitrarily set by the user.

Here, the collation unit 12 sequentially acquires a plurality of pieces of already journalized detail data stored in the detail data storage unit 200 from the last already journalized detail data, and performs a collation process on a single piece of journalizing target detail data which is input by the detail data input unit 11 until already journalized detail data having the matching content of the determination items is found. In the above-described way, for example, in a case where the same transaction is repeatedly performed between specific companies, collation is performed in order from the last already journalized detail data, and thus it is possible to find already journalized detail data matching journalizing target detail data in terms of the content of the determination items in a short period of time.

The collation unit 12 may use only already journalized detail data corresponding to a predetermined time (for example, three months before) before the present time among a plurality of pieces of already journalized detail data stored in the detail data storage unit 200 as collation process targets. In a case where already journalized detail data matching the journalizing target detail data in terms of the content of the determination items is not found even if all of the pieces of already journalized detail data corresponding to the predetermined time before the present time are collated, a message indicating the fact is output. In this case, the user manually sets an account title for the journalizing target detail data. In the above-described way, it is not necessary to set all of an enormous amount of already journalized detail data stored in the detail data storage unit 200, including the past old transactions, as collation targets, and it is possible to prevent a problem that a collation time longer than necessary is required for a single piece of journalizing target detail data.

When a collation process is performed on a single piece of journalizing target detail data, the collation unit 12 collates the content of the journalizing target detail data from the leading content in order, and finishes the collation process on the journalizing target detail data at a time point at which matching or mismatching of the content of the set determination items is determined. In a case where a plurality of different pieces of content for the same determination item are included in a single piece of journalizing target detail data, a subsequent extraction process is stopped at a time point at which the first content of the determination item is extracted, and collation is performed on the basis of the extracted content of the determination item.

For example, in a case where only the essential “detail item” is set as a determination item, the collation unit 12 sequentially reads the content of journalizing target detail data from the leading content, and extracts the content of the detail item. In a case where a plurality of pieces of content of the detail item are included in a single piece of journalizing target detail data, a subsequent extraction process is stopped at a time point at which the first content of the detail item is extracted. On the other hand, similarly, the content of the detail item (initial content in a case where a plurality of pieces of content of the detail item are included) is also extracted from the already journalized detail data read from the detail data storage unit 200. It is determined whether or not the (leading) content of the detail item extracted from the journalizing target detail data matches the (leading) content of the detail item extracted from the already journalized detail data.

In a case where a plurality of items including the essential detail item are set as determination items among the commodity code, the detail item, the department code, and the department name, the collation unit 12 determines whether or not journalizing target detail data matches already journalized detail data according to the above-described procedures for each determination item. In a case where matching is determined for all of the set determination items, it is determined that the journalizing target detail data matches the already journalized detail data. In other words, in a case where a plurality of items are set as determination items, a matching determination is not performed by prioritizing a predetermined item, and it is essential that matching occurs for all of the set determination items.

In a case where it is determined by the collation unit 12 that the content of the determination item matches each other, the automatic journalizing unit 13 sets the same account title as an account title set for a transaction related to the already journalized detail data matching the journalizing target detail data which is input by the detail data input unit 11 through the collation, for a transaction related to the journalizing target detail data. The detail data recording unit 14 stores the journalizing target detail data for which the account title is set through automatic journalizing in the detail data storage unit 200 as already journalized detail data.

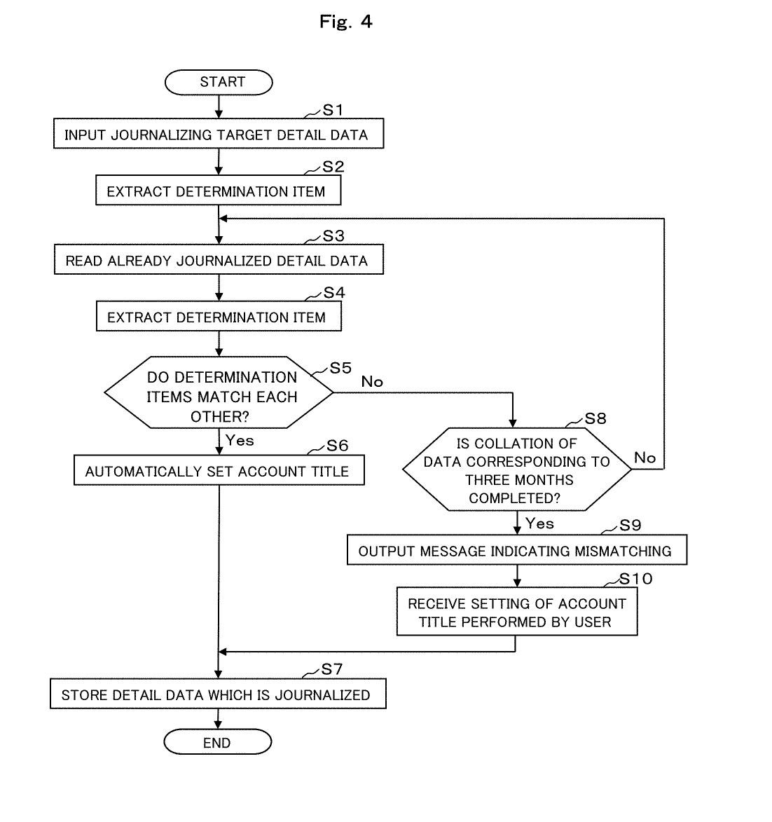

FIG. 4 is a flowchart illustrating an operation example of the automatic journalizing device 100 according to the present embodiment, configured as described above. The flowchart of FIG. 4 illustrates an operation example in a case where a transaction related to a single piece of journalizing target detail data is automatically journalized. In a case where transactions related to a plurality of pieces of journalizing target detail data are automatically journalized, processes in the flowchart of FIG. 4 may be repeatedly performed.

First, the detail data input unit 11 inputs a single piece of journalizing target detail data (step 31). Next, the collation unit 12 extracts the content of set determination items from the input journalizing target detail data (step S2). Here, in a case where a plurality of pieces of content for a single determination item are included in the journalizing target detail data, the leading content is extracted.

The collation unit 12 reads a single piece of last already journalized detail data among a plurality of pieces of already journalized detail data stored in the detail data storage unit 200 (step S3). The content of the set determination items is extracted from the read already journalized detail data (step S4). Here, in a case where a plurality of pieces of content for a single determination item are included in the already journalized detail data, the leading content is extracted.

The collation unit 12 determines whether or not the (leading) content of the determination item extracted from the journalizing target detail data matches the (leading) content of the determination item extracted from the already journalized detail data (step S5). Here, in a case where a plurality of determination items are set, the collation unit 12 determines whether or not journalizing target detail data matches already journalized detail data for each of the set determination items.

In a case where it is determined that the content of the determination item matches each other between the journalizing target detail data and the already journalized detail data, the automatic journalizing unit 13 sets the same account title as an account title set for a transaction related to the already journalized detail data matching the journalizing target detail data through the collation, for a transaction related to the journalizing target detail data (step S6). The detail data recording unit 14 stores the journalizing target detail data for which the account title is set through automatic journalizing in the detail data storage unit 200 as already journalized detail data (step S7).

On the other hand, in a case where it is determined that the content of the determination item does not match each other between the journalizing target detail data and the already journalized detail data in step S5, the collation unit 12 determines whether or not all pieces of already journalized detail data corresponding to a predetermined time (for example, three months before) before the present time are collated (step S8). In a case where already journalized detail data which is not collated remains, the process returns to step S3, the next already journalized detail data is read from the detail data storage unit 200, and then the above-described collation process is performed.

In a case where all pieces of already journalized detail data corresponding to the predetermined time before the present time have been collated, the collation unit 12 outputs a message indicating that already journalized detail data matching the journalizing target detail data in terms of the content of the determination item is not found (step S9). Consequently, the automatic journalizing device 100 receives an operation of the user manually setting an account title for the journalizing target detail data (step S10). The detail data recording unit 14 stores the journalizing target detail data for which the account title is set by the user in the detail data storage unit 200 as already journalized detail data (step S7). As mentioned above, the process in the flowchart of FIG. 4 is finished.

As described above in detail, in the present embodiment, the content of input journalizing target detail data is collated with the content of already journalized detail data stored in the detail data storage unit 200, and it is determined whether or not the content of a determination item set in advance matches each other. In a case where it is determined that the content of the determination item matches each other, the same account title as an account title set for the already journalized detail data is set for the journalizing target detail data.

In the present embodiment configured as described above, already journalized detail data for which an account title has already been set is used to automatically journalize journalizing target detail data on the basis of the transaction content. Thus, according to the present embodiment, it is possible to automatically journalize detail data of each transaction without using a correspondence table related to a keyword. Consequently, it is possible to prevent the occurrence of a problem that automatic journalizing cannot be performed since there is no keyword of a correspondence table in a description of the transaction content, or wrong automatic journalizing is performed since a plurality of keywords are included in a description of the transaction content.

The above-described embodiment is only an example of an embodiment for carrying out the present invention, and thus the technical scope of the present invention should not be interpreted to be limited. In other words, the present invention may be implemented in various aspects without departing from the spirit thereof or the primary features.

What is claimed is:

1. An automatic journalizing device for transaction details comprising:
a collation unit that collates content of detail data which is input as a journalizing target with content of detail data itself which has already been journalized, so as to determine whether or not content of a determination item set in advance matches each other; and
an automatic journalizing unit that sets the same account title as an account title set for a transaction related to the already journalized detail data, for a transaction related to the detail data which is input as the journalizing target, in a case where the collation unit determines that the content of the determination item matches each other.

2. The automatic journalizing device for transaction details according to claim 1,
wherein the collation unit sequentially acquires a plurality of pieces of already journalized detail data stored in a detail data storage unit from the last detail data, and performs a collation process on a single piece of the detail data which is input as a journalizing target until detail data having the matching content of the determination item is found.

3. The automatic journalizing device for transaction details according to claim 2,
wherein the collation unit sequentially acquires detail data corresponding to a predetermined time before the present time among a plurality of pieces of already journalized detail data stored in the detail data storage unit from the last detail data, and performs the collation process on the single piece of detail data.

4. The automatic journalizing device for transaction details according to claim 1,
wherein the collation unit collates the content of the detail data which is input as the journalizing target in order from the leading content, and finishes the collation process on the detail data at a time point at which matching or mismatching of the content of the determination item is determined.

5. The automatic journalizing device for transaction details according to claim 1,
wherein, in a case where a plurality of the determination items are set, the collation unit determines whether or not the content of the detail data which is input as a journalizing target matches the content of the already journalized detail data for each of the plurality of set determination items, and determines that pieces of content of the determination items match each other between the detail data which is input as a journalizing target and the already journalized detail data in a case where the pieces of the content match each other for all of the plurality of determination items.

6. An automatic journalizing method for transaction details comprising:
causing a collation unit of an automatic journalizing device to collate content of detail data which is input as a journalizing target with content of detail data itself which has already been journalized, so as to determine whether or not content of a determination item set in advance matches each other; and
causing an automatic journalizing unit of the automatic journalizing device to set the same account title as an account title set for a transaction related to the already journalized detail data, for a transaction related to the detail data which is input as a journalizing target, in a case where the collation unit determines that the content of the determination item matches each other.

7. An automatic journalizing program for transaction details causing a computer to function as:
detail data input means for inputting journalizing target detail data;
collation means for reading detail data which has already been journalized stored in a detail data storage unit, and collating content of detail data which is input as a journalizing target by the detail data input means with content of the already journalized detail data itself read from the detail data storage unit, so as to determine whether or not content of a determination item set in advance matches each other; and
automatic journalizing means for setting the same account title as an account title set for the already journalized detail data, for the detail data which is input as the journalizing target, in a case where the collation means determines that the content of the determination item matches each other.
